(19) United States
(12) Patent Application Publication
(10) Pub. No.: US 2026/0036368 A1
(43) Pub. Date: Feb. 5, 2026

(54) DECOMPRESSION DRYING DEVICE AND DECOMPRESSION DRYING METHOD USING SAME

(71) Applicant: INIBIO CO., LTD., Bucheon-si Gyeonggi-do (KR)

(72) Inventors: Hyeon A YIM, Incheon (KR); Young Je KIM, Bucheon-si Gyeonggi-do (KR); A In PARK, Seoul (KR)

(73) Assignee: INIBIO CO., LTD., Bucheon-si Gyeonggi-do (KR)

(21) Appl. No.: 18/995,250

(22) PCT Filed: Jul. 26, 2023
(86) PCT No.: PCT/KR2023/010864

§ 371 Date: Jan. 16, 2025

(30) Foreign Application Priority Data
Jul. 27, 2022 (KR) 10-2022-0093335

(51) Int. Cl. F26B 21/10; F26B 21/00; F26B 21/12

(52) U.S. Cl. CPC F26B 21/10; F26B 21/004; F26B 21/12

(57) ABSTRACT

A decompression drying device includes, in addition to a conventional release valve for introducing external air to restore the inside of a drying chamber to a normal pressure after drying has been completed, a separate external air introduction means for introducing external air into the drying chamber when the pressure inside the drying chamber has reached near a target pressure during a decompression drying process. The decompression drying device is used for drying a pharmaceutical product and, in particular, is used for manufacturing a botulinum toxin dried cake. By introducing external air while finely adjusting its inflow amount when the pressure inside the drying chamber reaches near the target pressure during the decompression drying process, it is possible to prevent a phenomenon in which the pressure inside the drying chamber, particularly the pressure around a vial containing a liquid sample, rises and decreases significantly.

### TECHNICAL FIELD

The present invention relates to a decompression drying device and a decompression drying method using the same, and more particularly to a decompression drying device that introduces a small flow of external air into a chamber when the pressure in the chamber reaches near a target pressure during a decompression drying process, so that the pressure in the chamber near the target pressure does not fluctuate sharply and reaches the target pressure smoothly, and a decompression drying method using the same.

### BACKGROUND ART

In many occasions, products must be dehumidified and dried before launch. Typical drying processes adopt a high-temperature drying method, in which heat is applied to the products to evaporate moisture. However, for products whose properties are altered by heat, such as pharmaceuticals, drying methods with high temperature are often not applicable.

The freeze-drying method is being used to dry heat-sensitive products. In the freeze-drying method, cooling the liquid sample and then drying it under a reduced pressure are repeated to remove the moisture contained within. As shown in FIG. 1, when the liquid sample is cooled to a solid state and then subjected to a reduced pressure, the sample sublimes from a solid state to a gaseous state. This principle is utilized in the freeze-drying method, where the solvent in solid form transitions to gas form and is expelled by sublimation with a phase change from a solid to a gas.

The freeze-drying method is widely utilized as it can dry heat-sensitive samples such as pharmaceuticals without significantly damaging their properties. However, a number of steps are required for drying, such as cooling the liquid sample to solidify it, depressurizing the solid sample to remove the solvent by sublimation, and then re-drying the solvent remaining in the solid sample, etc. Further, only small amount of solvent can be removed by sublimation, which makes drying a time-consuming process. Additionally, the pressure required for sublimation from solid to gas is very low, requiring a device capable of producing a high vacuum state. In the case of pharmaceuticals such as botulinum toxin, the freezing step, which is an integral part of the freeze-drying process, can lead to the formation of ice nucleus or a partially-occurring imbalance in excipient concentration at freezing, which may lead to a decrease in activity caused by damages in protein structure.

A decompression drying method is being utilized as a drying method for drying heat-sensitive samples such as pharmaceuticals. As shown in FIG. 1, the decompression drying method does not involve freezing the liquid sample to a solid state as in the freeze-drying method, but it involves evaporating the liquid into a gas by reducing the pressure in the chamber where the liquid sample is placed to a pressure range below the vapor pressure curve of the liquid.

Since the decompression drying method does not undergo a heating process, it has advantages for drying heat-sensitive samples such as pharmaceuticals as it would not significantly damage their properties. Further, relatively large amount of solvent is removed by evaporation compared to the amount of solvent removed by sublimation, thereby time required for the drying process can be reduced compared to the freeze-drying method. In addition, since the pressure required for the decompression drying is in a higher range than that required for the freeze-drying method, the decompression drying does not require a high-vacuum device as for the freeze-drying method.

The configuration of a decompression drying device applied to the decompression drying method is shown in FIG. 2.

The interior of a drying chamber (1) where the sample is mounted is provided with a shelf (3) where the sample is placed. The shelf (3) is liftably actuated by a hydraulic cylinder (4) driven by a hydraulic unit (5), whereby the height of the shelf can be adjusted. The shelf adopts a hollow form to allow the passage of the heat medium therein. The drying chamber (1) is provided with a door (2) for sample retrieval. The sample is usually in liquid form in a vial. The drying chamber (1) is equipped with a vacuum sensor (9) for measuring internal pressure and a temperature sensor (6) for measuring internal temperature. The drying chamber (1) is also provided with a release valve (7) for allowing external air to be introduced into the drying chamber (1) so that the pressure inside the drying chamber (1) can be restored to normal pressure after the completion of the depression drying. A capsule filter (8) may be installed in front of the release valve to filter impurities from the external air.

The drying chamber (1) is connected to a condenser chamber (18) by an isolation valve (11). A vacuum pump (23) is installed in the condenser chamber (18). When the vacuum pump (23) is activated, the air inside the condenser chamber (18) and the drying chamber (1) is evacuated, reducing the pressure inside the condenser chamber (18) and the drying chamber (1). The condenser chamber (18) serves as a type of a cold trap. That is, if a large amount of gaseous solvent evaporated from the drying chamber (1) flows into the vacuum pump (23), it can cause the performance of the vacuum pump (23) to deteriorate. Thus, the gaseous solvent evaporated from the drying chamber (1) is heat exchanged within the condenser chamber (18) so that it is condensed and then discharged through the drain valve (41), thereby the amount of gaseous solvent flowing into the vacuum pump (23) is reduced. A condenser coil (15) is provided to heat exchange the gaseous solvent within the condenser chamber (18). The condenser coil (15) is in the form of a pipe through which a refrigerant flows, and heat exchange occurs between the gaseous solvent in the condenser chamber (18) and the refrigerant in the condenser coil (15), which has been phase changed and reduced in temperature by passing through the compressor (not illustrated), expansion valves (34, 36, 38), and the like, thereby the gaseous solvent inside the condenser chamber (18) is liquefied. The reference numbers 35, 37, and 39 refer to each of the solenoid valves installed in the refrigerant conduit, and the reference number 40 refers to a VBS valve provided across the vacuum pump (23).

To maintain the temperature of the shelf in a certain range or cool the same, a heat medium conduit is provided. The heat medium conduit is connected to penetrate the inside and outside of the drying chamber (1) and is configured to allow heat medium to flow within the shelf (3) inside the drying chamber (1). The heat medium exchanges heat with the refrigerant flowing inside the condenser coil (15) at a heat exchanger (31). The heat medium is supplied into the conduit through a heat medium supply valve (42), and a heat medium expansion tank (25) is provided in front of the heat medium supply valve (42). The reference number 28 refers to a check valve (28) for supplying the heat medium to the heat medium expansion tank, the reference number 27 refers to a relief valve (27) for relieving pressure changes inside the heat medium expansion tank, and the reference number 26 refers to a glass (26) for observing the inside of the heat medium expansion tank (25). When necessary, the heat medium flowing through the heat medium conduit is drained to the outside through the heat medium drain valve (29). The heat medium circulates through the conduit via a heat medium pump (30), and the temperature of the heat medium can be regulated by a heat medium heater (32) before it enters the drying chamber (1).

When decompression drying is started, the introduction of external air into the drying chamber (1) is blocked, and the vacuum pump (23) is driven to evacuate the air inside the drying chamber (1) and the condenser chamber (18), thereby reducing the pressure therein. The temperature of the shelf is maintained in a certain range as the heat medium circulates so that the temperature changes inside the drying chamber (1) is not large. When the pressure inside the drying chamber (1) becomes lower than the vapor pressure curve of the liquid solvent contained in the sample, the liquid solvent begins to evaporate. By maintaining internal pressure of the drying chamber (1) to a target pressure that has a pressure range lower than the vapor pressure of the liquid solvent, the liquid solvent contained inside the sample is evaporated and the sample is dried.

Accordingly, compared to freeze-drying, the decompression drying method has the advantage of reducing time required for drying and does not require the pressure inside the chamber to be maintained at the same high vacuum levels as freeze-drying.

However, the applicant has found that conventional decompression drying methods suffer from the following major drawbacks.

The conventional decompression drying method simply adopts a release valve (7) as a means of introducing external air into the drying chamber (1) to introduce external air and restore the internal pressure of the drying chamber (1) to normal pressure after the drying is completed. The release valve (7) was intended to introduce the external air into the chamber in large quantities, which is unable to precisely tune the degree of opening or to finely adjust the flow rate. In other words, the conventional decompression drying method lacked a means to finely introduce external air into the drying chamber (1) at the moment when the vacuum pump (23) is driven and the pressure inside the vacuum chamber (1) drops, i.e., at the time when decompression drying begins. Additionally, it did not recognize the need to introduce external air into the vacuum chamber (1) during decompression drying.

However, by the present inventors' research, it has been found that when the decompression drying is performed and the pressure inside of the vacuum chamber (1) approaches the target pressure value, a significant change in pressure is created inside the drying chamber (1), particularly near the vial containing the sample.

FIG. 4 shows the pressure change inside the drying chamber (1) during decompression drying where no external air or nitrogen gas is introduced into the drying chamber (1). It illustrates that when the inside of the drying chamber (1) is depressurized and the internal pressure reaches near the target pressure, the pressure change suddenly becomes extreme.

This is because, at the beginning of the decompression, the pressure inside the drying chamber (1) is still higher than the pressure on the vapor pressure curve of the liquid solvent and little evaporation of the liquid solvent occurs, but evaporation increases rapidly from the moment the pressure inside the drying chamber (1) drops below the vapor pressure curve of the liquid solvent, and the amount of solvent in gas phase increases sharply. When the pressure reaches the target pressure below the vapor pressure curve, the amount of the evaporated gaseous solvent becomes cumulatively larger, and the pressure changes inside the drying chamber (1) becomes extreme due to the pressure of the evaporated gaseous solvent.

The inventors found that these pressure changes do not simply end with an increase in the pressure inside the drying chamber (1), but results in a repetition of a spike above the target pressure, followed by a drop below the target pressure, and by a spike above the target pressure again, and so on.

The inventors also found that these pressure changes prevent the pressure inside the drying chamber from being stabilized at the target pressure and adversely affect the drying of samples.

### DETAILED DESCRIPTION

### Technical Objective

The technical objective of the present invention is to provide a decompression drying device capable of suppressing pressure changes inside the drying chamber and maintaining stable target pressure by resolving the problem of conventional decompression drying devices that do not have a means to introduce a small amount of external air into the vacuum chamber at the beginning of decompression drying.

Another technical objective of the present invention is to provide a decompression drying method utilizing the decompression drying device as described above.

The technical objectives of the present invention are not limited to those mentioned above, and other technical objectives not specifically mentioned herein will be apparent to one of ordinary skill in the art from the following descriptions.

### Means for Solving Technical Objective

A decompression drying device according to one embodiment of the present invention to solve the above problems is characterized in that, in addition to a conventional release valve for introducing external air to restore the inside of the drying chamber to normal pressure after drying has been completed, the device comprises a separate external air introduction means for introducing external air into the drying chamber when the pressure inside the drying chamber has reached a target pressure during the decompression drying process.

Furthermore, the separate external air introduction means is characterized in that the amount of external air introduction can be adjusted in a micro range by finely tuning the valve opening.

The separate external air introduction means is further characterized in that it comprises an automatic vacuum regulating valve, which is automatically activated in response to pressure changes inside the chamber.

The separate external air introduction means is further characterized in that the separate external air introduction means comprises a manual valve to maintain a constant flow, arranged in parallel with the automatic vacuum regulating valve.

The decompression drying device of the present invention is characterized in that when the interior of the drying chamber is depressurized and the pressure approaches the target pressure, both the manual valve and the automatic vacuum regulating valve are simultaneously opened to introduce external air into the drying chamber, wherein a constant flow rate is provided through the manual valve and the flow rate flowing through the automatic vacuum regulating valve is finely adjusted. As a result, the amount of external air flowing into the drying chamber can be finely controlled, thereby allowing the amount of external air flowing into the drying chamber to be varied depending on the target pressure, and at the same time allowing the amount of external air flowing into the drying chamber to be adjusted according to the pressure condition inside the drying chamber.

Furthermore, the decompression drying device according to one embodiment of the present invention is characterized in that it is used for drying pharmaceutical products.

Furthermore, the decompression drying device according to one embodiment of the present invention is characterized in that it is particularly used in the manufacture of botulinum toxin dried cakes.

Furthermore, the decompression drying device according to one embodiment of the present invention is characterized in that it is operated at a pressure condition of 1,500 m Torr to 60,000 m Torr and at a temperature condition of 3° C. to 25° C. inside the drying chamber for the manufacture of botulinum toxin dried cakes.

The decompression drying device according to one embodiment of the present invention is also characterized in that the decompression drying is performed until the moisture content of the botulinum toxin dried cake reaches below 3%.

Furthermore, the decompression drying method according to one embodiment of the present invention is characterized in that when the pressure inside the drying chamber approaches a target pressure during the decompression drying process, external air is introduced into the drying chamber to suppress the pressure change in the drying chamber near the target pressure.

In addition, the separate external air introduction means used in the decompression drying method is characterized in that the amount of external air introduction can be adjusted in a micro range by finely tuning the valve opening.

The separate external air introduction means used in the decompression drying method is characterized in that it comprises an automatic regulating valve that is automatically operated according to the pressure change inside the chamber.

The separate external air introduction means is further characterized in that it comprises an automatic regulating valve, which is automatically operated in response to pressure changes inside the chamber.

The separate external air introduction means is also characterized in that it comprises a manual valve to maintain a constant flow, arranged in parallel with the automatic vacuum regulating valve.

The decompression drying method of the present invention is characterized in that when the pressure inside of the drying chamber is depressurized and the pressure approaches the target pressure, both the manual valve and the automatic vacuum regulating valve are simultaneously opened to introduce external air into the drying chamber, wherein a constant flow rate is provided by the manual valve and the flow rate flowing through the automatic vacuum regulating valve is finely adjusted. As a result, the amount of external air flowing into the drying chamber can be finely adjusted, thereby allowing the flow rate of external air flowing into the drying chamber to be varied depending on the target pressure, and at the same time allowing the flow rate of external air flowing into the drying chamber to be adjusted according to the pressure condition inside the drying chamber.

Furthermore, the decompression drying method according to one embodiment of the present invention is characterized in that it is used for drying pharmaceutical products.

Furthermore, the decompression drying method according to one embodiment of the present invention is characterized in that it is particularly used in the manufacture of botulinum toxin dried cakes.

Furthermore, the decompression drying method according to one embodiment of the present invention is characterized in that it is operated at a pressure condition of 1,500 m Torr to 60,000 m Torr and a temperature condition of 3° C. to 25° C. inside the drying chamber for the manufacture of the botulinum toxin dried cake.

Furthermore, the decompression drying method according to one embodiment of the present invention is characterized in that the decomposition drying is performed until the moisture content of the botulinum toxin dried cake reaches below 3%.

### Working Effect of the Invention

According to the present invention, it is possible to prevent the pressure inside the drying chamber, particularly the pressure around the vials containing the liquid sample, from rising and falling significantly by introducing external air while finely tuning the amount of external air when the pressure inside the drying chamber approaches the target pressure during the decompression drying process. This ensures that the pressure inside the drying chamber remains stable at the target pressure.

### BRIEF DESCRIPTION OF DRAWINGS

FIG. 1 is a phase diagram illustrating the change of state of water.

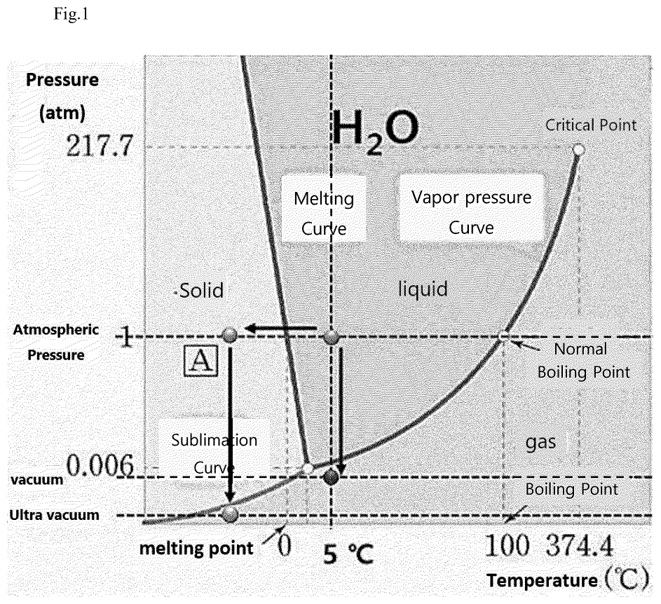

FIG. 2 is a schematic diagram of a conventional decompression drying device.

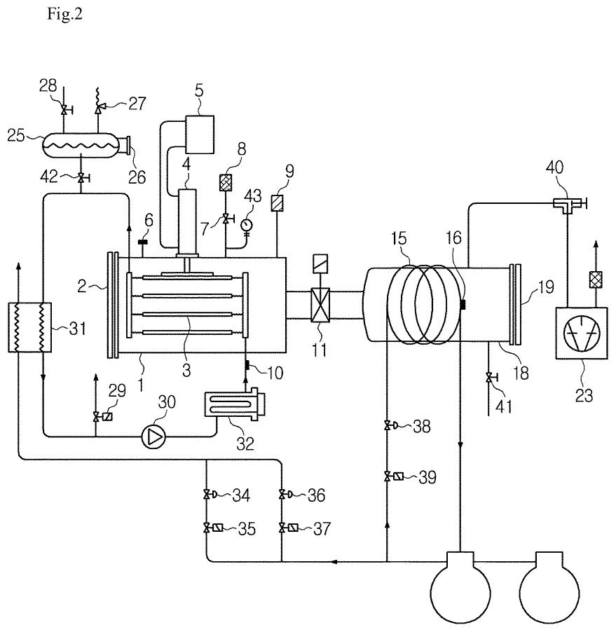

FIG. 3 is a schematic diagram illustrating a decompression drying device according to one embodiment of the present invention.

FIG. 4 is a pressure change diagram illustrating the pressure change inside a drying chamber according to a conventional decompression drying device.

FIG. 5 is a pressure change diagram illustrating the pressure change inside a drying chamber when the pressure inside the drying chamber is controlled by introducing external air into the drying chamber during the decompression drying process according to one embodiment of the present invention.

### MODE FOR CARRYING OUT THE INVENTION

The terms and words used in this specification and the claims of the patent are not to be construed as restrictive to their ordinary or dictionary sense. They are to be interpreted in a meaning and concept consistent with the technical idea of the invention, in accordance with the principle that the inventor may define the concept of a term or word to best describe his invention. It is also to be understood that the embodiments described herein, and the configurations shown in the drawings are merely one embodiment in which the invention is practiced and are not intended to exhaust the technical ideas of the invention, and that there may be various equivalents, modifications, and examples of applications which can be substituted for them at the time of filing.

The terms used in this specification and the claims of the patent, such as first, second, A, B, and the like, may be used to describe various elements, but the above elements are not to be limited by such terms. These terms are used only to distinguish one component from another. For example, a first component may be named a second component, and similarly, a second component may be named a first component, without departing from the scope of the present invention. The term “and/or” includes any combination of a plurality of related recited items or any one of a plurality of related recited items.

The terms used in this specification and in the claims of the patent are only intended to describe only particular embodiments and are not intended to limit the invention. Expressions in the singular include the plural unless the context clearly indicates otherwise. The terms “including” or “having” and similar expressions in this application are to be understood as not precluding the presence or addition of any feature, number, step, action, component, part, or combination thereof described in the specification.

In this specification and the claims, whenever a component is described as “connected” to another component, it should be understood to include direct connections as well as connections through other components, and only when a component is described as “directly connected” or “immediately connected” should it be understood to be connected one component to another component without any other components in between. Similarly, other expressions describing the relationship between components should be understood in the same way.

Unless otherwise defined, all terms used herein, including technical or scientific terms, shall have the same meaning as commonly understood by one of the ordinary skills in the art to which the present invention belongs.

Terms such as defined in commonly used dictionaries are to be construed to have meanings consistent with their meaning in the context of the relevant art and are not to be construed in an idealized or overly formal sense unless expressly defined in this application.

Further, each configuration, process, manufacturing process or method, etc. included in each embodiment of the present invention may be shared within a range that does not technically contradict each other.

Embodiments of the present invention will now be described in more detail with reference to the accompanying drawings.

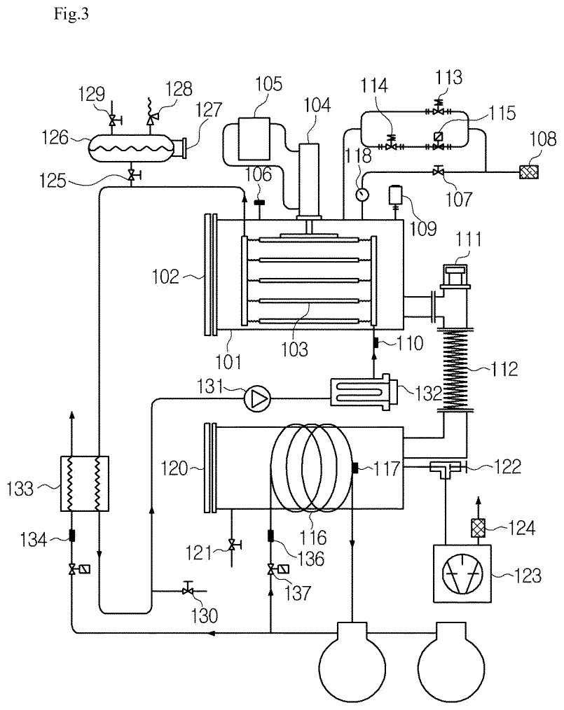

The configuration of the decompression drying device applied in the drying method of the invention is shown in FIG. 3.

The interior of a drying chamber (101) where the sample is mounted is equipped with a shelf (103) where the sample is placed. The shelf (103) is liftably actuated by a hydraulic cylinder (104) driven by a hydraulic unit (105), whereby the height of the shelf can be adjusted. The shelf adopts a hollow form to allow the passage of the heat medium therein. The drying chamber (101) is provided with a door (102) for sample retrieval. The sample is usually in liquid form in a vial. The drying chamber (101) is equipped with a vacuum sensor (109) for measuring internal pressure and a temperature sensor (106) for measuring internal temperature. The drying chamber (101) is also provided with a release valve (107) for allowing external air to be introduced into the drying chamber (101) so that the pressure inside the drying chamber (101) can be restored to normal pressure after the completion of the depression drying. A capsule filter (108) may be installed in front of the release valve (107) to filter impurities from the external air. A vacuum gauge (118) may also be provided behind the release valve (107) to measure the pressure within the external air introduction piping.

The drying chamber (101) is connected to a condenser chamber via an isolation valve (111). A vacuum pump (123) is installed in the condenser chamber. When the vacuum pump (123) is activated, the air inside both the condenser chamber and the drying chamber (101) is evacuated, reducing the pressure inside the condenser chamber and the drying chamber (101). The condenser chamber serves as a type of a cold trap. That is, if a large amount of gaseous solvent evaporated from the drying chamber (101) flows into the vacuum pump (123), it can cause the performance of the vacuum pump (123) to deteriorate. Thus, the gaseous solvent evaporated from the drying chamber (101) is heat exchanged within the condenser chamber so that it is condensed and then discharged through the drain valve (121), thereby the amount of gaseous solvent flowing into the vacuum pump (123) is reduced. A condenser coil (116) is provided to heat exchange the gaseous solvent within the condenser chamber. The condenser coil (116) is in the form of a pipe through which a refrigerant flows, and heat exchange occurs between the gaseous solvent inside the condenser chamber and the refrigerant in the condenser coil (116), which has been phase changed and reduced in temperature by passing through the compressor (the reference number of which is not illustrated), expansion valves (134, 136), and the like, thereby the gaseous solvent inside the condenser chamber is liquefied. The reference number 137 refers to a solenoid valve installed in the refrigerant conduit, the reference number 122 refers to a VBS valve provided across the vacuum pump (23), and the reference number 124 refers to an oil mist filter that filters oil contained in the gas exhausted from the vacuum pump (123).

To maintain the temperature of the shelf (103) in a certain range or cool the same, a heat medium conduit is provided. The heat medium conduit is connected to penetrate the inside and outside of the drying chamber (101) and is configured to allow heat medium to flow within the shelf (103) inside the drying chamber (101). The heat medium exchanges heat with the refrigerant flowing inside the condenser coil (116) at a heat exchanger (133). The heat medium is supplied into the conduit through a heat medium supply valve (125), and a heat medium expansion tank (126) is provided in front of the heat medium supply valve (125). The reference number 129 refers to a check valve for supplying the heat medium to the heat medium expansion tank, the reference number 128 refers to a pressure relief valve for relieving pressure changes inside the heat medium expansion tank, and the reference number 127 refers to a glass for observing the inside of the heat medium expansion tank (126). When necessary, the heat medium flowing through the heat medium conduit is drained to the outside through the heat medium drain valve (130). The heat medium circulates through the conduit via a heat medium pump (131), and the temperature of heat medium can be regulated by a heat medium heater (132) before it enters the drying chamber (101).

When decompression drying is started, the introduction of external air into the drying chamber (101) is blocked, and the vacuum pump (123) is driven to evacuate the air inside the drying chamber (101) and the condenser chamber, thereby reducing the pressure therein. The temperature of the shelf is maintained in a certain range as the heat medium circulates so that the temperature changes inside the drying chamber (101) is not large. When the pressure inside the drying chamber (101) becomes lower than the vapor pressure curve of the liquid solvent contained in the sample, the liquid solvent begins to evaporate. By maintaining internal pressure of the drying chamber (101) to a target pressure that has a pressure range lower than the vapor pressure of the liquid solvent, the liquid solvent contained inside the sample is evaporated and the sample is dried.

As the pressure inside the drying chamber (101) approaches the target pressure, the amount of liquid solvent evaporated increases. This creates pressure inside the drying chamber (101) due to the evaporated liquid solvent. The greater the amount of liquid solvent, the larger corresponding pressure changes within the drying chamber (101). There is a concern about the phenomenon of a rapid rise and fall in pressure inside the drying chamber (101), particularly around the vials containing the sample placed on the shelf (103), at the moment that the amount of liquid solvent evaporating reaches its maximum as the target pressure is approached.

In the depression drying device according to one embodiment of the present invention, as the pressure inside the drying chamber (101) approaches the target pressure, the separate external air introduction means is opened to introduce external air into the drying chamber (101) in coordination with the pressure inside the drying chamber (101).

The separate external air introduction means comprises a manual valve (114) to maintain a constant flow of external air, arranged in parallel with an automatic vacuum regulating valve (113), which is set to finely adjust the flow rate based on the pressure conditions inside the chamber.

The separate external air introduction means may be provided in the form of a bypass to the release valve (107), which is conventionally provided for restoring the pressure inside the drying chamber (101) to normal pressure after the completion of the decompression drying. In this way, the conventional release piping lines can be utilized except for the bypassed portion of the piping lines for introducing external air, which is advantageous for space utilization.

Optionally, the separate air introduction means may also be provided at a separate location from the release valve (107).

The conventional release valve (107) was not used for fine-tuning the pressure inside the drying chamber (1), but rather for restoring the internal pressure of the drying chamber (1) to normal pressure, which was maintained at a low pressure during the decompression drying process, so that a large amount of external air can be introduced at once, and there was no need to finely tune the amount of external air introduced.

In comparison, the separate external air introduction means of the present invention is not intended to restore the internal pressure of the drying chamber (101) to normal pressure. Rather, it is equipped to introduce external air in a small amount to control the pressure inside the drying chamber in the decompression drying process, so that the amount of external air introduced is smaller than that of the release valve (107) and the amount of external air introduced can be controlled within a micro range.

Preferably, the separate external air introduction means of the present invention is implemented to be automatically operated in response to the internal pressure of the drying chamber (101).

According to a preferred embodiment, when the inside of the drying chamber (101) is depressurized to approach the target pressure, the automatic vacuum regulating valve (113) is opened to allow external air to enter in. Simultaneously, turning on/off switch (115) is switched to the on position, which allows external air to enter the manual valve (114) side as well.

The manual valve (114) may be set to allow a constant flow therein and may be set to allow for a higher flow rate of external air compared to that of the automatic vacuum regulating valve (113). When the amount of external air to be introduced into the drying chamber (101) is large, it is often difficult to achieve the required amount of air introduced by the automatic vacuum regulating valve (113) alone. Thus, a significant portion of the amount of external air to be introduced into the drying chamber (101) can be obtained through the manual valve (114).

The automatic vacuum regulating valve (113) can finely tune the amount of external air entering based on the pressure conditions inside the drying chamber (101). Thus, adjusting the opening of the automatic vacuum regulating valve (113) allows for optimization of the pressure conditions inside the drying chamber (101).

Thus, a preferred embodiment of the present invention is configured so that when the inside of the drying chamber (101) is depressurized to approach the target pressure, the automatic vacuum regulating valve (113) opens to allow external air to enter, and at the same time the on/off switch (115) is switched to on position to allow external air to enter the manual valve (114) side, and the opening of the automatic vacuum regulating valve (113) is then controlled to adjust the overall amount of external air entering the inside of the drying chamber (101).

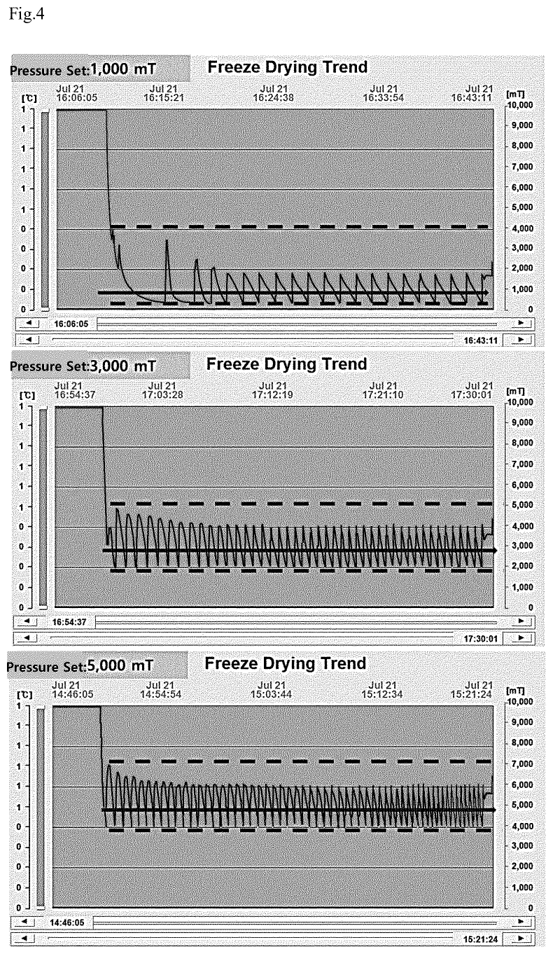

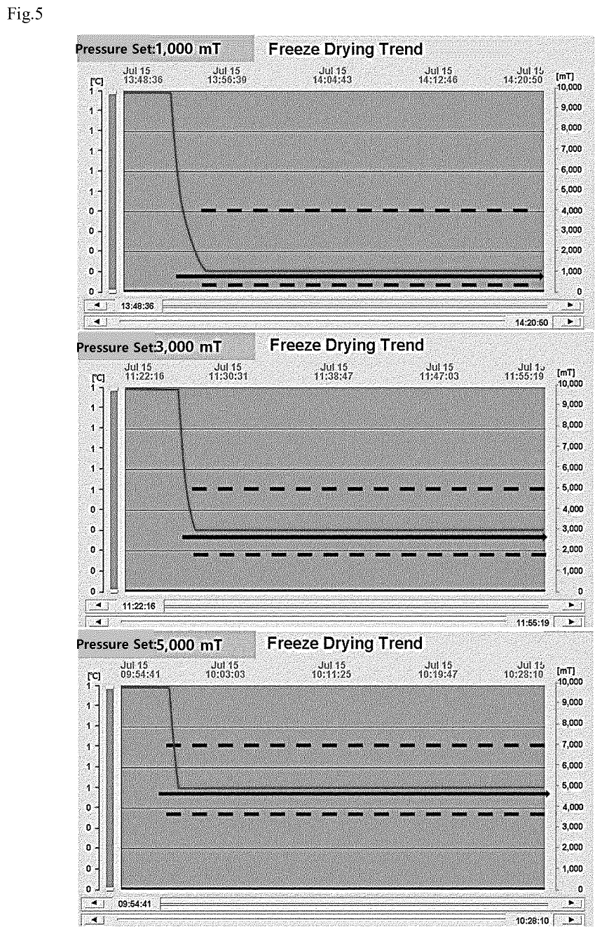

FIG. 4 is a pressure change diagram illustrating the pressure change inside a drying chamber according to a conventional decompression drying device, and FIG. 5 is a pressure change diagram illustrating the pressure change inside a drying chamber when the pressure inside the drying chamber is controlled by introducing external air into the drying chamber during the process of decompression drying according to one embodiment of the present invention.

As can be seen from FIG. 4, when the pressure inside the drying chamber (101) approaches the target pressure, the pressure inside the drying chamber rises and falls rapidly for a certain time period. It can also be seen that the pressure drops to a range below the target pressure. In decompression drying, the amount of evaporation is determined by the pressure conditions, and if the internal pressure of the drying chamber rises or falls rapidly, it greatly influences the evaporation of the liquid solvent.

In comparison, as can be seen from FIG. 5, when the pressure inside the drying chamber is near the target pressure while using the decompression drying device of the present invention and the automatic vacuum regulating valve (113) is operated to introduce a trace amount of external air, the target pressure is stably maintained without a sharp increase or decrease in pressure, even when the pressure inside the drying chamber reaches close to the target pressure. The dashed lines in FIG. 5 show the maximum pressure rise and pressure drop that occurs near the target pressure when no additional external air introduction device is activated.

Therefore, according to the present invention, it can be experimentally confirmed that when the pressure inside the drying chamber approaches near the target pressure during the decompression drying process, by introducing external air with fine tuning of the amount of external air, the phenomenon that the pressure inside the drying chamber, particularly around the vial containing the liquid sample, rises and falls significantly can be prevented. Further, it can be confirmed that the pressure inside the drying chamber can be stably maintained at the target pressure.

The present invention can be effectively applied to the drying processes of pharmaceutical products whose properties are easily altered by heat.

The present invention is particularly applicable to the drying process of botulinum toxin, for which there are concerns about decreased activity due to damages to the protein structure caused by localized ice nucleation or imbalance in excipient concentration during conventional freeze-drying process as well as damages caused by the boiling over of the liquid solvent during conventional decompression drying process.

The following describes a decompression drying process applicable to the drying of botulinum toxin. The process is described in detail in Korean Patent Application No. 10-2021-0155208, filed by the applicant of this application on Nov. 11, 2011, which was granted in 2021, and in a PCT application to be filed by the applicant of the present application, which claims priority from the above application. The descriptions therein are summarized as follows:

Traditionally, botulinum toxin has been dried using a freeze-drying process. However, as mentioned above, the freeze-drying process inevitably involves a freezing process and removes moisture through vaporization, which is a time-consuming process (approximately 18-48 hours) and leads to problems such as the formation of ice nucleation or an imbalance in excipient concentration.

Accordingly, the applicant has made efforts and researched to develop an optimized botulinum toxin decompression drying method that maintains its efficacy and stability. As a result, the applicant has found that by efficiently controlling parameters related to the drying process, such as pressure and temperature, it is possible to protect the protein, i.e., botulinum toxin, from external stimuli generated during the process and significantly shorten the drying time.

Specifically, the applicant has revealed that the decompression drying at pressure condition of 1,500 mTorr to 60,000 mTorr and temperature condition of 3° C. to 25° C. are preferred.

More specifically, the decompression drying may be performed under the following pressures: 1,500 to 60,000 mTorr, 1,500 to 55,000 mTorr, 1,500 to 50,000 mTorr, 1,500 to 45,000 m Torr, 1,500 to 40,000 mTorr, 1,500 to 35,000 mTorr, 1,500 to 30,000 mTorr, 1,500 to 25,000 mTorr, 1,500 to 20,000 mTorr, 1,500 to 15,000 mTorr, 1,500 to 14,000 mTorr, 1,500 to 13,000 m Torr, 1,500 to 12,000 mTorr, 1,500 to 11,000 mTorr, 1,500 to 10,000 mTorr, 1,500 to 9,000 m Torr, 1,500 to 8,000 m Torr, 1,500 to 7,000 mTorr, 1,500 to 6,000 m Torr, 1,500 to 5,000 m Torr, 1,500 to 4,000 m Torr, 1,500 to 3,500 mTorr, 1,500 to 3,000 m Torr, 1,500 to 2,500 m Torr, 1,500 to 2,000 m Torr, 2,500 to 3,000 m Torr, 2,500 to 3,500 m Torr, 2,500 to 4,000 m Torr, 2,500 to 4,500 mTorr, 2,500 to 5,000 mTorr, 2,500 to 6,000 mTorr, 2,500 to 7,000 mTorr, 2,500 to 8,000 mTorr, 2,500 to 9,000 mTorr, 2,500 to 10,000 mTorr, 2,500 to 11,000 mTorr, 2,500 to 12,000 mTorr, 2,500 to 13,000 mTorr, 2,500 to 14,000 mTorr, 2,500 to 15,000 mTorr, 2,500 to 20,000 m Torr, 2,500 to 25,000 mTorr, 2,500 to 30,000 mTorr, 2,500 to 35,000 mTorr, 2,500 to 40,000 m Torr, 2,500 to 45,000 m Torr, 2,500 to 50,000 mTorr, 2,500 to 55,000 mTorr, or 2,500 to 60,000 m Torr.

More specifically, the decompression drying may be performed under the following pressures: 3,000 to 3,500 mTorr, 3,000 to 4,000 mTorr, 3,000 to 4,500 mTorr, 3,000 to 5,000 m Torr, 3,000 to 6,000 m Torr, 3,000 to 7,000 m Torr, 3,000 to 8,000 m Torr, 3,000 to 9,000 m Torr, 3,000 to 10,000 mTorr, 3,000 to 11,000 mTorr, 3,000 to 12,000 mTorr, 3,000 to 13,000 m Torr, 3,000 to 14,000 m Torr, 3,000 to 15,000 mTorr, 3,000 to 20,000 m Torr, 3,000 to 25,000 m Torr, 3,000 to 30,000 mTorr, 3,000 to 35,000 mTorr, 3,000 to 40,000 m Torr, 3,000 to 45,000 m Torr, 3,000 to 50,000 mTorr, 3,000 to 55,000 mTorr, or 3,000 to 60,000 mTorr.

Outside of the above ranges, damage to the protein may occur due to phenomena such as boiling, resulting in the inability to obtain a perfectly dried product due to insufficient drying.

More specifically, the decompression drying may be performed under the following temperatures: 3° C. to 25° C., 5° C. to 25° C., 7° C. to 25° C., 9° C. to 25° C., 11° C. to 25° C., 12° C. to 25° C., 3° C. to 20° C., 5° C. to 20° C., 7° C. to 20° C., 9° C. to 20° C., 11° C. to 20° C., 12° C. to 20° C., 3° C. to 18° C., 3° C. to 16° C., 3° C. to 14° C., or 3° C. to 12° C.

Outside of the above ranges, the structural instability of botulinum toxin may increase, or physical damage and deformation may occur due to high or low temperatures, which could result in reduced efficacy.

In addition, the decompression drying may be performed until the moisture content of the botulinum toxin dried cake reaches below 3%.

The decompression drying may involve drying the botulinum toxin under reduced pressure for at least 0.5 hours, or for between 0.5 hours and 4 hours.

Specifically, it may be performed in a range of 0.5 hours to 4 hours, 0.5 hours to 3 hours, 0.5 hours to 2 hours, 0.5 hours to 1 hour, 1 hour to 4 hours, 2 hours to 4 hours, or 3 hours to 4 hours.

On the other hand, this process of decompression drying requires a steady and controlled transition from ambient pressure in normal atmospheric conditions to the target pressure.

The present application is designed to address the need for stable control of pressure inside the drying chamber as it is reduced from ambient pressure to a target pressure when the decompression drying is initiated, ensuring the pressure remains stable near the target pressure without rapid fluctuations.

According to the invention, it is possible to prevent the pressure inside the drying chamber, particularly around the vials containing the liquid sample, from rising and falling rapidly during the decompression drying process by introducing external air while finely tuning the amount of external air as the pressure inside the drying chamber approaches the target pressure. Therefore, the present invention ensures that the pressure inside the drying chamber remains stable at the target pressure. Further, the present invention prevents localized ice nucleation from forming in the sample, or the liquid solvent from boiling over, thereby protecting the sample from damage.

### DESCRIPTION OF REFERENCE NUMBERS

101: Drying Chamber
102: Door
103: Shelf
104: Hydraulic Cylinder
105: Hydraulic Unit
106: Temperature sensor
107: Release Valve
108: Capsule Filter
109: Vacuum Sensor
111: Isolation Valve
112: Bellows
113: Automatic Vacuum Regulating Valve
114: Manual Valve
115: On/Off Switch
116: Condenser Coil
117: Temperature Sensor
120: Door
121: Drain Valve
122: VBS Valve
123: Vacuum Pump
124: Oil Mist Filter
125: Heat Medium Supply Valve
126: Heat Medium Expansion Tank
127: Glass
128: Pressure Relief Valve
129: Check Valve
130: Heat Medium Drain Valve
131: Heat Medium Pump 132: Heat Medium Heater
133: Heat Exchanger
134: Expansion Valve
136: Expansion Valve
137: Solenoid Valve

1. A decompression drying device comprising:
a separate external air introduction means for introducing external air into a drying chamber when pressure inside the drying chamber has reached near a target pressure during a decompression drying process.

2. The decompression drying device of claim 1,
wherein the separate external air introduction means is automatically activated when the pressure inside the drying chamber reaches the target pressure.

3. The decompression drying device of claim 1,
wherein the separate external air introduction means comprises an automatic vacuum regulating valve that adjusts an amount of external air introduction in a micro range by finely tuning the valve opening.

4. The decompression drying device of claim 3,
wherein the separate external air introduction means for introducing external air comprises a manual valve to maintain a constant flow, arranged in parallel with the automatic vacuum regulating valve, so that when the pressure inside the drying chamber reaches the target pressure, both the manual valve and the automatic vacuum regulating valve are simultaneously opened to introduce external air into the drying chamber, and then a flow rate of external air into the automatic vacuum regulating valve is adjusted to regulate the overall flow rate of external air into the drying chamber.

5. The decompression drying device of claim 4,
wherein the manual valve allows for a higher flow rate compared to the automatic vacuum regulating valve.

6. The decompression drying device of claim 1,
wherein the decompression drying device is used in the manufacture of pharmaceutical products.

7. The decompression drying device of claim 1,
wherein the decompression drying device is used in the manufacture of botulinum toxin dried cakes.

8. The decompression drying device of claim 1,
wherein the decompression drying is performed under the following pressure conditions: 1,500 m Torr to 60,000 mTorr, 1,500 to 55,000 m Torr, 1,500 to 50,000 m Torr, 1,500 to 45,000 mTorr, 1,500 to 40,000 mTorr, 1,500 to 35,000 mTorr, 1,500 to 30,000 mTorr, 1,500 to 25,000 mTorr, 1,500 to 20,000 mTorr, 1,500 to 15,000 mTorr, 1,500 to 14,000 mTorr, 1,500 to 13,000 mTorr, 1,500 to 12,000 mTorr, 1,500 to 11,000 m Torr, 1,500 to 10,000 m Torr, 1,500 to 9,000 mTorr, 1,500 to 8,000 mTorr, 1,500 to 7,000 m Torr, 1,500 to 6,000 mTorr, 1,500 to 5,000 mTorr, 1,500 to 4,000 mTorr, 1,500 to 3,500 m Torr, 1,500 to 3,000 mTorr, 1,500 to 2,500 mTorr, 1,500 to 2,000 mTorr, 2,500 to 3,000 m Torr, 2,500 to 3,500 mTorr, 2,500 to 4,000 mTorr, 2,500 to 4,500 mTorr, 2,500 to 5,000 m Torr, 2,500 to 6,000 mTorr, 2,500 to 7,000 m Torr, 2,500 to 8,000 m Torr, 2,500 to 9,000 m Torr, 2,500 to 10,000 mTorr, 2,500 to 11,000 mTorr, 2,500 to 12,000 mTorr, 2,500 to 13,000 mTorr, 2,500 to 14,000 mTorr, 2,500 to 15,000 mTorr, 2,500 to 20,000 m Torr, 2,500 to 25,000 mTorr, 2,500 to 30,000 mTorr, 2,500 to 35,000 mTorr, 2,500 to 40,000 m Torr, 2,500 to 45,000 mTorr, 2,500 to 50,000 mTorr, 2,500 to 55,000 mTorr, 2,500 to 60,000 m Torr.

9. The decompression drying device of claim 1,
wherein the decompression drying is performed under the following pressure conditions: 3,000 to 3,500 mTorr, 3,000 to 4,000 mTorr, 3,000 to 4,500 m Torr, 3,000 to 5,000 mTorr, 3,000 to 6,000 m Torr, 3,000 to 7,000 mTorr, 3,000 to 8,000 mTorr, 3,000 to 9,000 mTorr, 3,000 to 10,000 mTorr, 3,000 to 11,000 mTorr, 3,000 to 12,000 mTorr, 3,000 to 13,000 mTorr, 3,000 to 14,000 mTorr, 3,000 to 15,000 mTorr, 3,000 to 20,000 mTorr, 3,000 to 25,000 mTorr, 3,000 to 30,000 mTorr, 3,000 to 35,000 mTorr, 3,000 to 40,000 mTorr, 3,000 to 45,000 mTorr, 3,000 to 50,000 mTorr, 3,000 to 55,000 m Torr, or 3,000 to 60,000 mTorr.

10. The decompression drying device of claim 1,
wherein the decompression drying is performed under the following temperature conditions: 3° C. to 25° C., 5° C. to 25° C., 7° C. to 25° C., 9° C. to 25° C., 11° C. to 25° C., 12° C. to 25° C., 3° C. to 20° C., 5° C. to 20° C., 7° C. to 20° C., 9° C. to 20° C., 11° C. to 20° C., 12° C. to 20° C., 3° C. to 18° C., 3° C. to 16° C., 3° C. to 14° C., or 3° C. to 12° C.

11. The decompression drying device of claim 1,
wherein the decompression drying is performed under the following ranges: at least 0.5 hours, 0.5 hours to 4 hours, 0.5 hours to 3 hours, 0.5 hours to 2 hours, 0.5 hours to 1 hour, 1 hour to 4 hours, 2 hours to 4 hours, or 3 hours to 4 hours.

12. The decompression drying device of claim 7,
wherein the decompression drying is performed until moisture content of the botulinum toxin dried cake reaches below 3%.

13. A decompression drying method, characterized by comprising a step of
utilizing a separate external air introduction means for introducing external air into a drying chamber when pressure inside the drying chamber has reached near a target pressure during a decompression drying process, so that the pressure inside the drying chamber can be adjusted by introducing external air into the drying chamber when the pressure inside the drying chamber has reached near the target pressure during the decompression drying process.

14. The decompression drying method of claim 13,
wherein the separate external air introduction means is automatically activated when the pressure inside the drying chamber reaches a target pressure.

15. The decompression drying method of claim 13,
wherein the separate external air introduction means comprises an automatic vacuum regulating valve that adjusts an amount of external air introduction in a micro range by finely tuning the valve opening.

16. The decompression drying method of any one of claim 15,
wherein the separate external air introduction means for introducing external air comprises a manual valve to maintain a constant flow, arranged in parallel with the automatic vacuum regulating valve, so that when the pressure inside the drying chamber reaches the target pressure, both the manual valve and the automatic vacuum regulating valve are simultaneously opened to introduce external air into the drying chamber, and then a flow rate of external air into the automatic vacuum regulating valve is adjusted to regulate the overall flow rate of external air into the drying chamber.

17. The decompression drying method of any one of claim 16,
wherein the manual valve allows for a higher flow rate compared to the automatic vacuum regulating valve.

18. The decompression drying method of any one of claim 17,
wherein the decompression drying method is used in the manufacture of a pharmaceutical product.

19. The decompression drying method of any one of claim 18,
wherein the decompression drying method is used in the manufacture of botulinum toxin dried cakes.

20. The decompression drying method of any one of claim 19,
wherein the decompression drying is performed under the following pressure conditions: 1,500 m Torr to 60,000 mTorr, 1,500 to 55,000 mTorr, 1,500 to 50,000 mTorr, 1,500 to 45,000 mTorr, 1,500 to 40,000 mTorr, 1,500 to 35,000 mTorr, 1,500 to 30,000 mTorr, 1,500 to 25,000 mTorr, 1,500 to 20,000 mTorr, 1,500 to 15,000 mTorr, 1,500 to 14,000 mTorr, 1,500 to 13,000 mTorr, 1,500 to 12,000 mTorr, 1,500 to 11,000 m Torr, 1,500 to 10,000 mTorr, 1,500 to 9,000 mTorr, 1,500 to 8,000 mTorr, 1,500 to 7,000 mTorr, 1,500 to 6,000 mTorr, 1,500 to 5,000 mTorr, 1,500 to 4,000 m Torr, 1,500 to 3,500 mTorr, 1,500 to 3,000 mTorr, 1,500 to 2,500 mTorr, 1,500 to 2,000 m Torr, 2,500 to 3,000 m Torr, 2,500 to 3,500 mTorr, 2,500 to 4,000 mTorr, 2,500 to 4,500 mTorr, 2,500 to 5,000 m Torr, 2,500 to 6,000 mTorr, 2,500 to 7,000 m Torr, 2,500 to 8,000 mTorr, 2,500 to 9,000 m Torr, 2,500 to 10,000 mTorr, 2,500 to 11,000 mTorr, 2,500 to 12,000 mTorr, 2,500 to 13,000 mTorr, 2,500 to 14,000 mTorr, 2,500 to 15,000 mTorr, 2,500 to 20,000 mTorr, 2,500 to 25,000 mTorr, 2,500 to 30,000 mTorr, 2,500 to 35,000 mTorr, 2,500 to 40,000 m Torr, 2,500 to 45,000 m Torr, 2,500 to 50,000 m Torr, 2,500 to 55,000 mTorr, or 2,500 to 60,000 m Torr.

21. The decompression drying method of any one of claim 20,
wherein the decompression drying is performed under the following pressure conditions: 3,000 to 3,500 mTorr, 3,000 to 4,000 mTorr, 3,000 to 4,500 m Torr, 3,000 to 5,000 mTorr, 3,000 to 6,000 mTorr, 3,000 to 7,000 mTorr, 3,000 to 8,000 mTorr, 3,000 to 9,000 mTorr, 3,000 to 10,000 mTorr, 3,000 to 11,000 mTorr, 3,000 to 12,000 m Torr, 3,000 to 13,000 mTorr, 3,000 to 14,000 mTorr, 3,000 to 15,000 mTorr, 3,000 to 20,000 mTorr, 3,000 to 25,000 mTorr, 3,000 to 30,000 mTorr, 3,000 to 35,000 m Torr, 3,000 to 40,000 mTorr, 3,000 to 45,000 mTorr, 3,000 to 50,000 mTorr, 3,000 to 55,000 m Torr, or 3,000 to 60,000 mTorr.

22. The decompression drying method of any one of claim 21,
wherein the decompression drying under the following temperature conditions: 3° C. to 25° C., 5° C. to 25° C., 7° C. to 25° C., 9° C. to 25° C., 11° C. to 25° C., 12° C. to 25° C., 3° C. to 20° C., 5° C. to 20° C., 7° C. to 20° C., 9° C. to 20° C., 11° C. to 20° C., 12° C. to 20° C., 3° C. to 18° C., 3° C. to 16° C., 3° C. to 14° C., or 3° C. to 12° C.

23. The decompression drying method of any one of claim 13,
wherein the decompression drying is performed under the following ranges: at least 0.5 hours, 0.5 hours to 4 hours, 0.5 hours to 3 hours, 0.5 hours to 2 hours, 0.5 hours to 1 hour, 1 hour to 4 hours, 2 hours to 4 hours, or 3 hours to 4 hours.

24. The decompression drying method of any one of claim 19,
wherein the decompression drying is performed until content of the botulinum toxin dried cake reaches below 3%.
